(19) United States
(12) Patent Application Publication
(10) Pub. No.: US 2008/0243533 A1
(43) Pub. Date: Oct. 2, 2008

(54) Digital Dance-a-thonTM

(76) Inventor: Elena Marie Mildenberger, St. Augustine, FL (US)

Correspondence Address: Elena Marie Mildenberger, 128 13th St., St. Augustine, FL, 32080, US

(21) Appl. No.: 12/054,197

(22) Filed: Mar. 24, 2008

Related U.S. Application Data
(60) Provisional application No. 60/908,087, filed on Mar. 26, 2007.

(51) Int. Cl. G06Q 30/00

(52) U.S. Cl. 705/1

(57) ABSTRACT

The invention provides an improvement on a dance-a-thon fundraiser. The Digital Dance-A-Thon™ utilizes an interactive dance video game such as Dance Dance Revolution® to provide the songs and control the dance-a-thon. The video game brings an interactivity to the dance-a-thon as participants are scored based on their dance ability. The video game displays a choreographed dance routine that the dancers must follow. Participants are able to select their song and level of difficulty. Participants are able to compete against other participants based on scores earned. Two or more participants dance on interactive dance mats with the remaining participants dancing on non-interactive mats or directly on the floor. Participants rotate onto the interactive mats. Sponsors provide money to the dancers based on length of time danced, number of dances completed or for participation in the Digital Dance-a-Thon™.

### BACKGROUND OF THE INVENTION

### Brief Summary of the Invention

Schools and youth organizations have long raised money by selling products and running events. Events similar to walk-a-thons and dance-a-thons allow participants to raise money by being sponsored to participate. Sponsor revenue can be based on the mere fact of participating or by length of time of participation or units completed. Units completed can be laps walked, ropes jumped, songs danced, goals scored or similar measurement.

Dance-a-thons have traditionally utilized a Disc Jockey or a music player such as a stereo to provide the songs. A Digital Dance-A-Thon™ utilizes a video game such as Dance Dance Revolution® to provide the songs. The video game brings an interactivity to the dance-a-thon as participants are scored based on their dance ability. The video game displays a choreographed dance routine that the dancers dance to. Participants are able to select their song and level of difficulty. Participants are able to compete against other participants based on scores earned.

### DETAILED DESCRIPTION OF THE INVENTION

Digital Dance-a-Thon™ uses interactive dance programs including but not limited to Computer Software, Internet Content and/or Video Games in conjunction with interactive dance mats, interactive dance mats combined with non-interactive dance mats or exclusively non-interactive dance mats to allow groups of people to raise money through dance-a-thons. Sponsors provide money to the dancers based on length of time danced, number of dances completed or for participation in the dance-a-thon.

Groups purchase interactive dance programs that they use for the dance-a-thon. Collection envelopes with a grid for collecting sponsor information are provided. Prize information is optionally printed on collection envelopes. Participants solicit sponsors through in person requests, phone requests, mail requests and Internet requests.

Participants remit sponsor money collected in the collection envelopes. All participating individuals dance in the dance-a-thon. Prizes are provided to the participants as an incentive.

Songs for the dance-a-thon are generated by an interactive dance video game such as the Dance Dance Revolution® video game that is available for use on Windows based computers, Playstation, Xbox, Game Cube and Wii video game systems. Internet broadcast can also be used to generate the songs.

Participants in the dance-a-thon can dance on interactive mats that are connected to the interactive dance program. Participants can also dance on non-interactive mats that are not connected to the interactive dance programs or simply dance on the floor.

Participants follow the dance moves displayed by the interactive dance programs. Participants dancing on interactive mats can control the song choice and difficulty level. These dancers receive scores, grades and/or ratings based on their dance skills. Participants rotate to allow all dancers, if time allows, to dance on the interactive mats.

What is claimed

1. A method for raising money said method comprising the steps of: utilizing individuals to collect sponsors for dancing in a dance-a-thon; individuals dancing in a dance-a-thon; the music for the dance-a-thon generating from an interactive dance video game; the dance moves to be performed in the dance-a-thon generated by the interactive dance video game.

2. The method according to claim 1, further comprised of a group of individuals dancing together with certain individuals dancing on interactive dance mats with remaining dancers dancing on non-interactive dance mats or dancing directly on floor.

3. The method according to claim 1, further comprised of a group of individuals dancing on interactive dance mats connected to an interactive dance video game; controlling the dance songs and receiving scores and feedback based on their dance skills.
